(19) United States
(12) Patent Application Publication
(10) Pub. No.: US 2019/0164236 A1
(43) Pub. Date: May 30, 2019

(54) METHOD OF MATCHING RENEWABLE ENERGY PRODUCTION TO END-USER CONSUMPTION VIA BLOCKCHAIN SYSTEMS

(71) Applicants: Timothy MAYNE, London (GB); Serge UMANSKY, Lausanne (CH)

(72) Inventors: Timothy MAYNE, London (GB); Serge UMANSKY, Lausanne (CH)

(21) Appl. No.: 16/194,172

(22) Filed: Nov. 16, 2018

Related U.S. Application Data
(63) Continuation of application No. PCT/GB2017/051418, filed on May 19, 2017.
(60) Provisional application No. 62/392,032, filed on May 19, 2016.
(60) Provisional application No. 62/493,124, filed on Jun. 23, 2016.

(51) Int. Cl. G06Q 50/06; G06Q 40/04; G06Q 20/38

(52) U.S. Cl. CPC G06Q 50/06; G06Q 20/389; G06Q 40/04

(57) ABSTRACT

This invention enables a transparent matching of the electricity produced from renewable sources with the electricity consumed by end-users that have a preference for clean energy. This goal is achieved through a system of tagging energy using blockchain tokens. The proposed system is transparent, incorruptible and efficient in managing energy blockchain tokens and creates a valuable information resource which can be leveraged to promote and support consumption and production of renewable energy.

### CROSS-REFERENCE TO RELATED APPLICATIONS

This application is a continuation of International Application No. PCT/GB2017/051418, filed May 19, 2017, which claims the benefit of U.S. provisional patent application No. 62/392,032, filed on May 19, 2016, and U.S. provisional patent application No. 62/493,124, filed on Jun. 23, 2016, the entire content of which is incorporated herein by reference.

### BACKGROUND OF THE INVENTION

### Field of the Invention

The present invention relates to computer implemented frameworks and methods configured to create, validate and manage blockchain tokens used to measure and tag individual units of electricity produced by power plants and match them with electricity volumes consumed by the purchasers of renewable energy. The invention provides a foundation for implementing an IT platform that facilitates the trade of electricity units with verifiable provenance while providing access to energy token data to stakeholders throughout the cycle of creation, re-sale and distribution, and consumption.

### Description of the Related Technology

The background description includes information that may be useful in understanding the present invention. It is not an admission that any of the information provided herein is prior art or relevant to the presently claimed invention, or that any publication specifically or implicitly referenced is prior art.

Blockchains have risen over the last few years predominantly through the prolific growth of cryptocurrencies. The most famous cryptocurrency is Bitcoin, launched in 2009, as described in the original paper openly published on May 24, 2009, by Satoshi Nakamoto titled “Bitcoin: A Peer-to-Peer Electronic Cash System” (see URL en.bitcoin.it/wiki/Bitcoin_white_paper).

As blockchain has become a more established technology, development has continued at an accelerating pace. Developments include applications of the existing Bitcoin blockchain for other purposes, unrelated to crypto currency, as well as the development of new blockchains altogether with greatly improved functionality. One notable development is the success of the smart contract blockchains. Smart contracts are digital assets that are controlled by a code implementing predetermined rules. Smart contracts are described in the Ethereum whitepaper “A Next-Generation Smart Contract and Decentralized Application Platform” (see URL https://github.com/ethereum/wiki/wiki/White-Paper).

Blockchains are classified according to the level of access to blockchain data. A public blockchain such as Bitcoin is one that places no restrictions on access to blockchain data and no restrictions on those who can submit transactions for inclusion into the blockchain. Alternatively, a private blockchain does restrict access to blockchain data and those who can submit transactions for inclusion into the blockchain.

Blockchains can also be classified according to restrictions on transaction processing. A permissionless blockchain is a blockchain that allows any entity to process transactions and publish them as a block on the blockchain. A permissioned blockchain restricts which entities can process transactions and publish them as a block on the blockchain.

Cryptocurrencies such as Bitcoin operate on the principle of applying proof-of-work (POW) principles to process transactions that are bound together in large encrypted blocks of data. The network node that successfully meets the proof-of-work requirements (i.e., generating a double hash value with a required number of leading zero bits) for the transaction block, has their block accepted by peers and receives a reward in the form of cryptocurrency.

Some newer blockchains use proof-of-stake methods to validate transactions instead of proof-of-work methods. Proof-of-stake methods ask users to prove ownership of their stake in the currency before allowing them to contribute to the consensus process, allowing a blockchain to achieve distributed consensus.

To date the above known proof-of-work (POW) systems and proof-of-stake (POS) systems have predominantly focused on transaction processing and authentication or automation of finance related activities. It has been under-appreciated that the same innovations may be applied to other industries, thus introducing similar levels of integrity and transparency to those that Bitcoin and other blockchain based technologies benefit from.

Although Bitcoin is probably the most famous application of POW, many others have applied POW to other areas of technology. For example, U.S. Pat. No. 7,356,696 to Jakobsson et al. titled “Proofs of Work and Bread Pudding Protocols”, filed Aug. 1, 2000, describes reusing stale computations of a POW to continue minting digital currency.

Another example of using POW further afield from cryptocurrency includes U.S. Pat. No. 7,600,255 to Baugher titled “Preventing Network Denial of Service Attacks Using an Accumulated Proof-of-work Approach”, filed Apr. 14, 2004. Baugher requires a computer client to generate a POW to access a service where the POW could include hashing a message until a desired number of leading bit-level zeros is found, similar to the POW of Bitcoin.

In a somewhat similar vein to Baugher, U.S. Pat. No. 8,412,952 to Ramzan et al. titled “Systems and Methods for Authenticating Requests from a Client Running Trialware Through a Proof of Work Protocol”, filed May 6, 2009, also uses POW to grant access to services. Ramzan describes generating a cryptographic puzzle if no authentication token is included with a service request to run trialware. The client making the request must solve the cryptographic puzzle in order to receive authentication to proceed with running the trialware.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Examples are used to assist readers understand the full function of the invention throughout the written description. The parameters used in any examples are also examples, and can vary depending upon the desired application of the invention in practice. In some examples, the numerical parameters should be construed in light of the number of reported significant digits and by applying ordinary rounding techniques. Parameters used in the examples include volumes of energy, time, location, and so forth, may be modified.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from a group for reasons of convenience and/or patentability. When any such inclusion or deletion occurs, the specification is herein deemed to contain the group as modified thus fulfilling the written description of all Markush groups used in the appended claims.

### SUMMARY

The inventive subject manner provides apparatus, systems and methods to measure and tag specific amounts of electricity produced by power plants and match them with volumes of electricity consumed by end-users. Individual units of electricity production will be represented by blockchain tokens to ensure the transparency, incorruptibility and efficiency of the system. The invention is intended to be used in three ways: (1) to allow end-users to directly express their preferences for specific forms of energy production (e.g. renewable energy production); (2) to allow the energy distribution companies that supply electricity to end-users (from herein referred to as retailers) to link their electricity supply to specific forms and sources of production and deliver tangible proof of provenance of the specific amounts of energy sold to end-users; (3) to allow energy companies that both produce electricity and sell it to end-users to deliver tangible proof of provenance of the energy they have produced and sold to end-users.

The current energy industry remains largely non-transparent to end-users. The provenance of electricity delivered to end-users remains completely unknown leaving no avenues for specific forms of production (e.g. renewable energy production) to distinguish themselves. This leaves end-users with very little options to express their preferences for certain types of energy sources.

As the global understanding of climate change and a general popular appreciation of sustainability of resources improves, a strong case has emerged for providing end-users with higher transparency into the provenance of electricity they are buying. The invention allows specific amounts of electricity generated by various producers to be identified and tagged at the point of production. Each tag is represented by a blockchain token (from here in referred to as an energy token) and can be assigned to end-users by energy distributers along with matching amounts of electricity. The energy tokens related to the units of electricity produced from the renewable sources can be purchased voluntarily by end-users as a way to transparently invest in renewable energy production and reduce their environmental footprint. Once delivered to an end-user energy tokens are non-transferable, ensuring that units of electricity production cannot be double-sold to unsuspecting buyers. The invention is valuable because it allows end-users to distinguish which forms of production are offered by retailers. Although units of electricity appear physically identical at the point of consumption, an end-user's choice in energy retailer determines which form of electricity production their money is supporting. Energy tokens offer end-users much needed visibility allowing them to influence the energy industry by expressing their preference for renewables.

While it is impossible to define which power plants generated the energy physically delivered to an end-user through the grid, there are clear financial flows which can be defined. In most countries with regulated energy markets it is as follows: (1) End-users buy electricity from energy retailers at fixed rates; (2) Energy retailers buy electricity either from a wholesale electricity market, or directly from generators or distributors through bilateral agreements; (3) Generators sell the electricity they produce either through a wholesale electricity market or through bilateral agreements to energy retailers and distributors.

The invention based on energy tokens allows energy retailers to link the electricity they deliver to end-users with a specific form of production (e.g. renewable energy production). By allowing distribution companies to demonstrate a link to a specific form of production, the invention gives end-users the opportunity to express their preference for particular forms of production (e.g. renewable energy production). For example, if energy retailers are rewarded for linking supplied electricity to renewable sources, then producers of renewable energy will be rewarded with the additional revenue from the energy tokens they generate.

Without the solution, end-users have no verifiable visibility into the forms of electricity production a distribution company supports. Further considering that electricity in the grid is physically identical, it comes as little surprise that end-users naturally gravitate towards the cheapest product available. The purpose of this invention is to provide the visibility required for end-users to make informed purchasing decisions, or at the very least to be informed about the purchasing decisions they currently make.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a flowchart showing the different supply chains used to deliver units of electricity to end-users.

FIG. 2 is a flowchart showing the different supply chains used to deliver energy tokens to end-users.

FIG. 3 is an overview of the workflow of an energy token; from the initial production of the unit of energy it represents, through to its final destination, the end-user.

FIG. 4 is an example of the information contained within an energy token.

FIG. 5 schematically shows the main components of an energy provision system according to an example implementation of the invention.

FIG. 6 schematically shows the main components of an energy source forming part of the energy provision system illustrated in FIG. 5.

FIG. 7 schematically shows the main components of an energy sink forming part of the energy provision system illustrated in FIG. 5.

FIG. 8 schematically shows the main components of a computing platform forming part of the energy provision system illustrated in FIG. 5.

### DETAILED DESCRIPTION OF CERTAIN INVENTIVE EMBODIMENTS

Described herein are computer implemented frameworks and methods to create energy tokens that prove the provenance of individual units of electricity. The purpose of an energy token is to facilitate and incentivise investment in specific forms of electricity production (e.g. renewable energy production). When an energy token is sold or assigned to an end-user, the end-user knows that they have invested in a specific form of electricity production. End-users can obtain energy tokens in two ways: (1) Buying electricity from an energy retailer that assigns energy tokens along with electricity; (2) Buying energy tokens directly from the wholesale market, facilitated by a centralised IT platform.

A blockchain is used to manage energy tokens to ensure the system is transparent, incorruptible and efficient in achieving its purpose. The term “blockchain token” or “token” is used in this document to describe any blockchain entity which can be used to facilitate trade or as a medium of trade; including but not limited to private, semi-private, or public blockchains, permissioned or non-permissioned blockchains, or some combination of these. This document focuses on using a centralised IT platform to emanate energy tokens, intermediate trade/transfer and facilitate the final delivery of energy tokens to end-users.

It should be noted that any language directed to a computer should be read to include any suitable combination of computing devices, including servers, interfaces, systems, databases, agents, peers, engines, controllers, or other types of computing devices operating individually or collectively. One should appreciate that individual computing devices comprise a processor configured to execute software instructions stored on a tangible, non-transitory computer readable storage medium (e.g., hard drive, solid state drive, RAM, flash, ROM, etc.). The software instructions preferably configure the computing device to be operable to provide the roles, responsibilities, and any other functionality as discussed below with respect to the disclosed apparatus. Further, the disclosed technologies can be embodied as a computer program product that comprises a non-transitory computer readable medium storing the software instructions that causes a processor to execute the disclosed steps. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

The subject matter is presented from the perspective of the following separate entities: (1) the energy generator; (2) the energy retailer (distributor); (3) the end-user. It should be appreciated that stakeholders can comprise of any combination of (1), (2) and/or (3). For example, a company may become a generator by investing in a renewable electricity power plant, supplying the power to themselves.

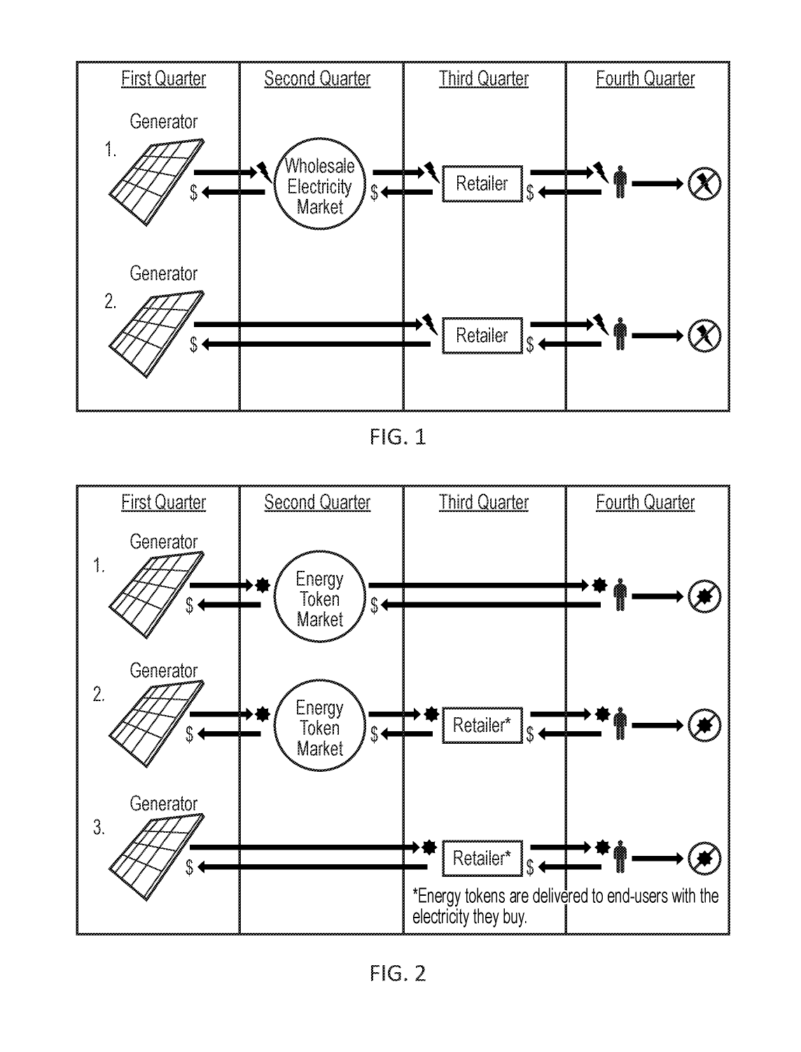

FIG. 1 is a flowchart showing two common supply chains used to sell units of electricity to end-users. The flowchart is broken into quarters that separate each stakeholder. The first quarter shows a generator producing a unit of electricity that is deliverable to the grid for transmission. The second quarter shows the wholesale electricity market through which generators may sell units of electricity to energy retailers/distributors. The third quarter shows the energy retailer/distributor that buys units of electricity and sell them to an end-user in the retail electricity market. The fourth quarter shows a unit of electricity being delivered to an end-user who consumes it.

FIG. 1 Part 1 shows a generator selling a unit of electricity in the wholesale electricity market to a distributor, who then sells it to an end-user for consumption. FIG. 1 Part 2 shows a generator selling a unit of electricity directly to a retailer through a bilateral agreement. The retailer then sells the unit of electricity to an end-user for consumption as in Part 1.

FIG. 2 is a flowchart showing the three ways that end-users can invest in energy tokens to support specific forms of electricity production. The flowchart is broken into quarters that separate each stakeholder. The first quarter shows the generators that receive an energy token for each unit of electricity produced. The second quarter shows the energy token market that some (but not all) tokens are sold through. The energy token market is facilitated by the centralised IT platform. The third quarter shows an energy retailer investing in an energy token to assign to an end-user along with a unit of electricity. The fourth quarter shows the energy token being delivered to an end-user, which, once received, can no longer be traded or transferred. This is an important property of an energy token designed to ensure that a token can only be resold until it is delivered to the end-user, therefore preventing energy tokens from being double-sold to end-users.

FIG. 2 Part 1 shows a generator selling an energy token through the energy token market directly to an end-user. Once delivered to the end-user the energy token can no longer be traded or transferred.

FIG. 2 Part 2 shows a generator selling an energy token through the energy token market to a retailer who then delivers it along with a unit of electricity to an end-user. The energy token market can be replaced by a wholesaler who has a contract with a generator and sells tokens on to various retailers. Energy tokens enable retailers to demonstrate to end-users the specific forms of energy production (e.g. renewable energy production) they invest in. Once delivered to the end-user the energy token can no longer be traded or transferred.

FIG. 2 Part 3 shows a generator selling an energy token directly to a retailer who then delivers it with a unit of electricity to an end-user. In this case the generator and retailer may be the same company, meaning the token may be transferred without payment to the retailer. The retailer then delivers the energy token with a unit of electricity to an end-user. This enables the retailer to demonstrate to the end-user their investment in a specific form of energy production (e.g. renewable energy production), possibly demonstrating their own production of specific forms of electricity. Once delivered to the end-user the energy token can no longer be traded or transferred.

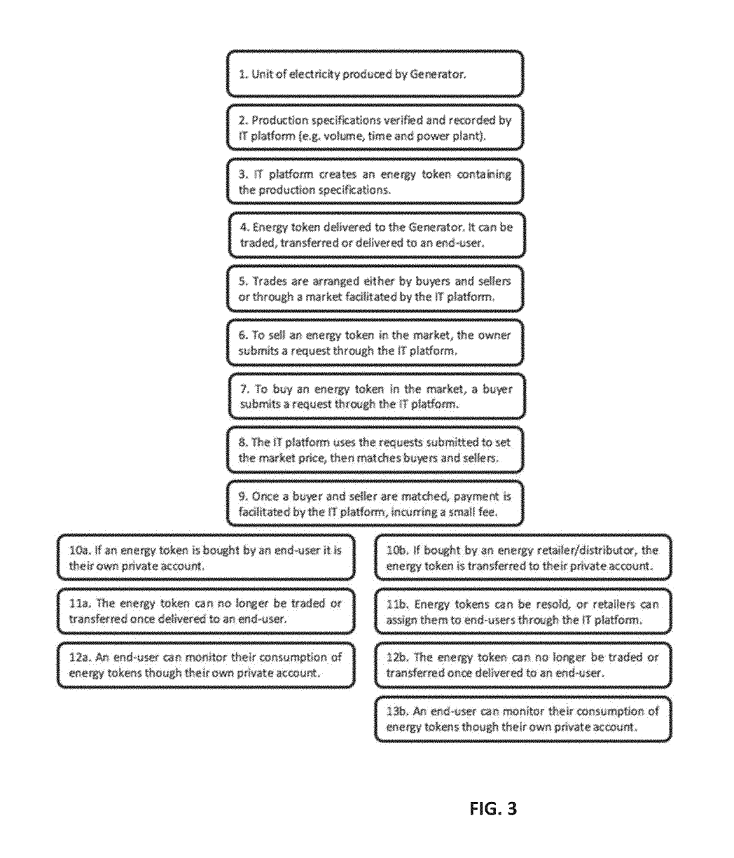

FIG. 3 is an overview of the energy token workflow from the initial production of the unit of energy it represents, through to delivery to the end-consumer and subsequent redemption. The redeemed tokens can be used by a consumer as a proof of provenance of energy consumed but can't be further resold. The junction at Part 10 is to highlight the difference between selling an energy token directly to an end-user, and selling an energy token to an energy retail company. When sold directly to an end-user, an energy token can no longer be traded or transferred. However, when sold to a retailer/distributor an energy token may be traded or transferred repetitively until assigned/sold to an end-user.

FIG. 3 Part 1 represents the physical generation of a unit of electricity. The only requirement to be eligible to receive an energy token is that the production properties can be sufficiently verified.

FIG. 3 Part 2 describes the verification process for each unit of electricity to produce an energy token. The production specifications include the time, volume and the identity of the power plant where a unit of electricity was produced. Energy tokens may include other production specifications. The verification process requires monitoring a power plant's output either with monitoring devices already in place, or a separate device installed that sends production data to the IT platform. The production specifications as well as the verification process may vary between power plants.

FIG. 3 Part 3 shows the creation of energy tokens. Once the production specifications have been sufficiently verified, the IT platform will create the energy token containing the production specifications. An energy token is a blockchain token which can be traded, transferred or delivered to other stakeholders over a blockchain. Different stakeholders have different levels of authorities in the blockchain. The IT platform is the only stakeholder which can issue the energy tokens. Generators, wholesalers and retailers can buy and sell energy tokens and either seller or otherwise assign them to the end-users. The end-users can only receive energy tokens either by buying them or receiving them as part of the contract for electricity supply contract with an energy retailer.

FIG. 3 Part 4 shows the process of delivering the energy token to the generator which produced the initial unit of electricity. A generator can then sell or transfer the energy token either directly to other stakeholders, or through the energy token market facilitated by the IT platform.

FIG. 3, Part 5 through Part 9, shows the process of selling energy tokens through the energy token market facilitated by the IT platform. Much like other exchange traded assets, the IT platform uses buy and sell orders to set a market price and to match buyers and sellers. Payment is facilitated by the IT platform (with a small fee) and the trade is finalised.

What happens from here depends on who the buyer is. Part 10a through Part 12a explain the process of having the energy token sold directly to an end-user. Part 10b through Part 13b explain the process of selling the energy token to an energy retailer who wishes to deliver the token to an end-user with the electricity they buy.

FIG. 3 Part 10a through Part 12a show that an energy token sold directly to an end-user is allocated to their account on the IT platform where they can monitor their consumption of energy tokens. The token is then redeemed to ensure that it can no longer be traded or transferred.

FIG. 3 Part 10b through Part 13b show that an energy token sold to an energy retailer is transferred to the retailer. Retailers can either resell energy tokens or deliver them to end-users with the electricity they sell them. Once delivered to an end-user the unit of electricity production is allocated to them through the IT platform, and the energy token is redeemed to ensure that it can no longer be traded or transferred.

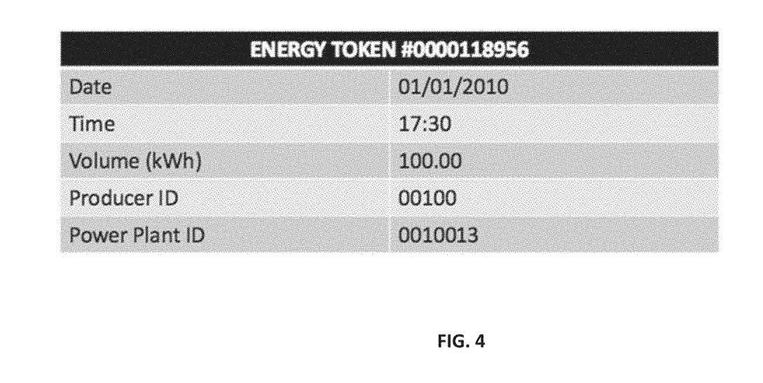

FIG. 4 shows the information contained in an energy token. The information requirements given in the figure are not fixed and may vary. They may also vary between power plants and include information not referred to in this document.

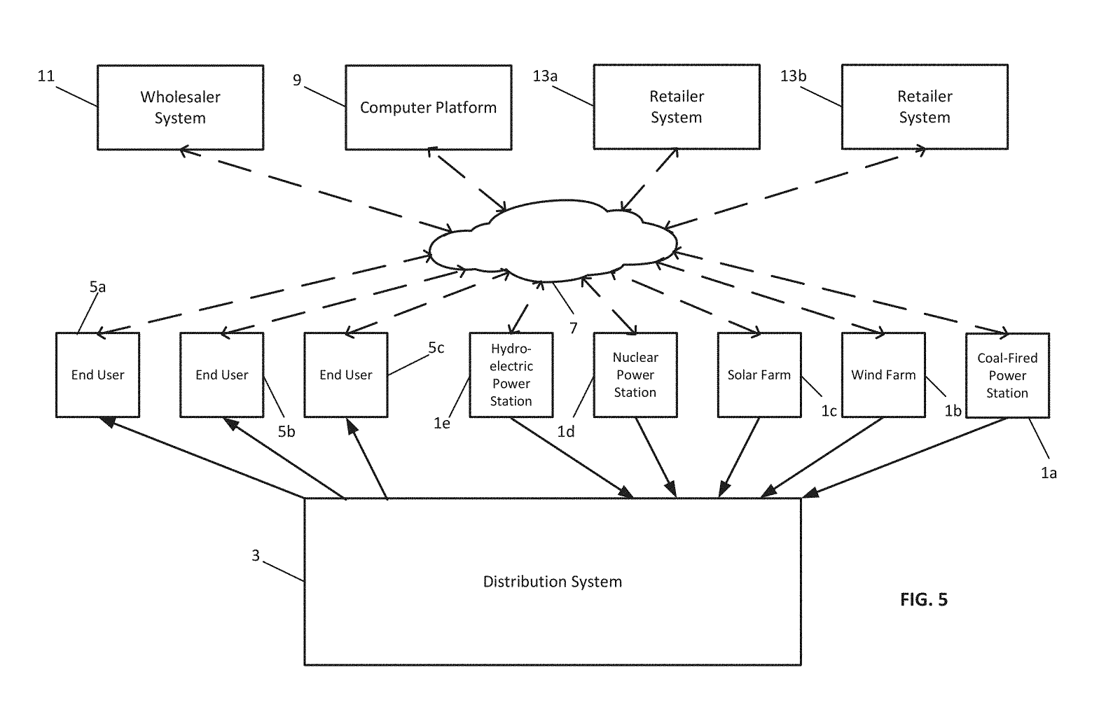

FIG. 5 shows an example of an energy provision system implementing the invention. As shown, the energy provision system includes a coal-fired power station 1a, a wind farm 1b, a solar farm 1c, a nuclear power station 1d and a hydroelectric power station 1d; collectively referred to as energy sources 1. It will be appreciated that many additional energy sources 1 may also be provided, which may be the same type or different types to the energy sources 1 illustrated in FIG. 5. The energy sources 1 provide power, via an energy distribution system 3, to end users 5a, 5b, 5c, collectively referred to hereafter as end users 5 or energy sinks 5.

The energy distribution system 3 is a conventional system including power lines and transformers. The energy distribution system may include storage devices for storing energy, for example so that energy generated at off-peak times can be stored and then provided for consumption at peak times. The nature of the energy distribution system 3 is such that the energy sources 1 contribute energy to a common energy pool, and the energy sinks 5 draw energy from that common energy pool. The energy sources 1 enter into supply agreements with an electricity wholesaler and possibly also electricity retailers, the electricity retailers may enter into a supply agreement with the electricity wholesaler or the energy sources 1, and each end user 5 enters into a supply agreement with one of the electricity retailers.

In accordance with the present invention, a blockchain application is used to link energy generated by the energy sources 1 with energy consumed by the energy sinks 5 by recording transfers of tokens corresponding to energy introduced into the energy provision system by the energy sources 1 in a blockchain. For the avoidance of doubt, this does not mean tracking energy introduced by each of the energy sources 1 because when energy is introduced into the common energy pool it is no longer possible to track its origin. However, tracking the transfer of energy tokens does enables a form of visualisation of the flow of energy through the energy provision system. This visualisation is useful in at least two respects, namely:
The visualisation allows a retailer to demonstrate to end users that energy consumed by the end users 5 is linked to energy produced by a particular energy source 1. In other words, the end user 5 can see that energy consumed by that end user 5 is matched by energy produced by a particular energy source that is not matched to energy consumed by any other end user 5.
The visualisation facilitates the reconciliation of payments required from the retailers to the wholesaler and the energy sources 1, and from the wholesaler to the energy sources 1, under the energy supply agreements. At present, this is a complex process resulting in such reconciliation taking significantly longer than is desirable.

The distributed blockchain application is formed by peer blockchain applications interconnected by a network 7, which may be the Internet or leased lines or both. In this example, a peer blockchain application is executed by each of the energy sources 1 and the energy sinks 5, as well as a computer platform 9, a wholesaler system 11 associated with the wholesaler and retailer systems 13a, 13b respectively associated with the retailers. In other examples, the execution of the peer blockchain applications may be remote from the associated apparatus, e.g. the peer blockchain application for an end user may not be implemented at the end user premises.

As shown in FIG. 6, each of the energy sources 1 includes an electricity generator 21 that generates electricity. The structure of the electricity generator 21 is governed by the form of production of electricity. For example, in the solar farm 1c the electricity generator 21 is a solar panel, in the wind farm 1b the electricity generator 21 is a wind turbine, in the coal-fired power station 1a the electricity generator 21 is a steam turbine, in the nuclear power station 1d the electricity generator 21 includes a nuclear reactor, and in the hydroelectric power station 1e the electricity generator 21 is a water turbine.

Electricity generated by the energy generator 21 is supplied to the energy distribution system 3 via an electrical output 23. The amount of energy introduced into the energy distribution system 3 via the electrical output is measured by a meter 25, which is also interconnected via a data bus 27 to processor circuitry 29, memory 31 and a network interface 33. The processor circuitry 29, the memory 31 and the network interface 33 are conventional components and accordingly will not be described in more detail herein. The memory 31 stores the peer blockchain application 35.

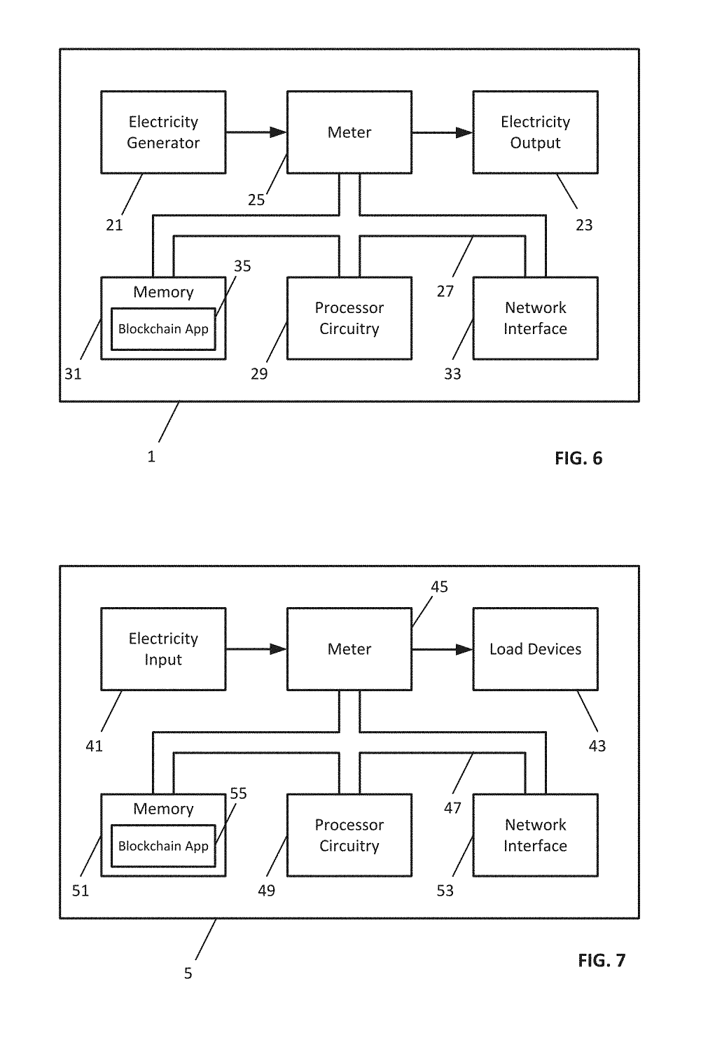

As shown in FIG. 7, each of the energy sinks 5 has an electrical input 41 via which electricity is received from the energy distribution system 3. The electricity is consumed by the electrical load devices 43 and the amount of energy consumed is measured by meter 45. In this example, the meter 45 is a smart meter and is interconnected by a data bus 47 to processor circuitry 49, memory 51 and a network interface 53. The processor circuitry 49, the memory 51 and the network interface 53 are conventional components and accordingly will not be described in more detail herein. The memory 51 stores the peer blockchain application 55.

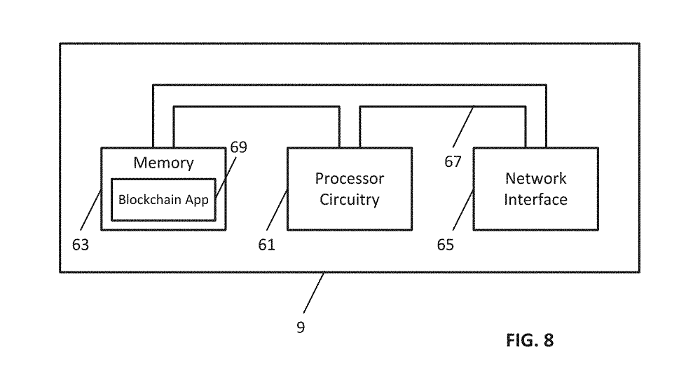

As shown in FIG. 8, the main components of the computer platform 9 are processor circuitry 61, memory 63 and a network interface 65 interconnected by a data bust 67. The processor circuitry 61, the memory 63 and the network interface 65 are conventional components and accordingly will not be described in more detail herein. The memory 63 stores the peer blockchain application 69. The structure of the retailer systems 11 and the wholesaler system 13 is the same as the structure of the computer platform 9 in that they include processor circuitry, memory and a network interface interconnected by a data bus, with the memory storing a peer blockchain application. The computer platform 9 facilitates the distributed blockchain application as will be discussed hereafter. In this example, the computer platform 9 also hosts an energy trading system enabling trading of energy.

Various different distributed blockchain applications could be utilised by the present invention. For example, the Ethereum blockchain application could be utilised. Preferably, a distributed blockchain application supporting smart contracts is utilised so that transfer of tokens can be associated with completion of contract terms such as supply of energy in return for payment. At least part of the smart contract functionality can be implemented within a token. Importantly, the distributed blockchain application of this example records transfer of tokens corresponding to energy introduced into the energy provision system, not transfer of funds in the form of currency or cryptocurrency (although this may be tracked separately).

The peer block chain applications that together make up the distributed block chain application need not all have the same functionality or the same access rights. In this embodiment, the peer blockchain application 35 associated with an energy source 1 is a first type of peer blockchain application, the peer blockchain application 55 associated with an energy sink 5 is a second type of peer blockchain application, the peer blockchain application 69 associated with the computer platform 9 is a third type of peer blockchain application, and the peer blockchain applications associated with the retailer systems 11 and the wholesaler system 13 is a fourth type of blockchain application. The differences in their functioning in this and other examples will be apparent from the following description of the operation of the distributed blockchain application.

The distributed blockchain application records data concerning the ownership of tokens. As well as keeping track of the current ownership of the tokens, the distributed blockchain application also generates a verifiable record of all the transactions in which ownership of one or more tokens is transferred. This record is referred to as the blockchain, as it constitutes a sequence of blocks with each block storing data associated with multiple transactions together with a reference to a previous block. Built into the blockchain are verification properties that enable the integrity of the blockchain to be assessed. The processing required to generate a block is typically much more complex than the processing required to verify the block. Accordingly, typically all peer blockchain applications have the functionality to verify the block whereas only a subset of peer blockchain applications have the functionality to generate a block (sometimes referred to as block mining or block forging). In this example, only the peer blockchain applications 35 associated with the energy sources 1 have the functionality to generate a block, which is advantageous because the energy required for block generation can be sourced locally. The generation of a block may be performed using, for example, proof-of-work or proof-of-stake techniques.

The storage of the blockchain is distributed between the peer blockchain applications in addition to the processing. By storing the blockchain in a distributed and heavily redundant manner, the data within the blockchain is difficult to corrupt and accordingly the blockchain is secure. Not all peer blockchain applications need store the entire blockchain, although in this example the peer blockchain application 69 of the computing platform 9 stores the entire blockchain. In this way, a stakeholder can access transaction data associated with a token through data communication with the computing platform 9.

The distributed blockchain application can either work with a preset number of tokens or can include functionality for generating new tokens. In one example in which the distributed blockchain application works with a present number of tokens, the peer blockchain application 69 of the computing platform 9 has token issuing functionality; the meter 25 of an energy source 1 measures energy introduced into the energy distribution system 3 by that energy source 1 and reports the measurements to the computing platform 9, which in response issues a corresponding number of tokens to the energy source 1 by crediting an account associated with that energy source 1 with the corresponding number of tokens. The computer platform 9 may digitally sign issued tokens to verify authenticity. In such an example, the transaction transferring tokens from the computing platform 9 to the energy source 1 can be used to verify the provenance of the corresponding energy. In another example the distributed blockchain application includes functionality to generate additional tokens which is incorporated into the functionality of the peer blockchain application 35 of the energy sources 1; the meter 25 of an energy source 1 measures energy introduced into the energy distribution system 3 by that energy source 1 and reports the measurements to the peer blockchain application 35, which in response issues a corresponding number of tokens to the energy source 1 by generating a transaction crediting an account associated with that energy source 1 with the corresponding number of tokens.

As discussed above, according to the invention each token is associated with an amount of energy introduced into the energy provision system. In this way, each token represents an amount of energy. In an example, the energy introduced into the energy provision system is measured in unit sizes of, for example 1 kWh, and a token is issued for each unit of introduced energy. In alternative examples, different tokens could be associated with different amounts of energy.

In this embodiment, each token stores data relating to the provenance of the of the corresponding energy, in particular:
the form of production of the corresponding energy;
the time of production of the corresponding energy; and
the location of production of the corresponding energy.

For example, a token could indicate that the corresponding electricity was generated using solar energy at a particular location and at a particular time. It will be appreciated that electricity providers are increasingly offering “green” tariffs for energy generated by renewable sources, but given the nature of the energy distribution system to date it has not been possible to demonstrate adequately that electricity provided under such a tariff actually matches energy generated using renewable sources. The present invention provides a mechanism for doing this. In this example, for simplicity, a token also includes a Boolean field indicating whether or not the corresponding energy was generated from a renewable energy source. The indicated provenance can be verified by the blockchain.

The peer blockchain applications 55 at the energy sinks 5 have associated transactions rules that restrict the further transfer of tokens from the energy sinks to prevent tokens being transferred from an energy sink in association with an energy trade. In this way, tokens corresponding to energy that has been consumed cannot be associated with further energy trading. The transaction rules may prohibit further transfer of tokens from the energy sinks 5, or specify that the tokens must be transferred either to the computer platform 9 to undergo a redemption process (which may be preferable when the distributed blockchain application utilises a fixed number of tokens) or to a bucket account which is used to accumulate tokens representing consumed electricity.

The energy distribution system 3 has associated energy losses, that is energy that it is input by the energy sources 1 that does not reach the energy sinks 5. Such energy losses could arise from transmission losses or losses at energy storage devices. In this example, the amount of lost energy is taken into account by the distributed blockchain application. In an example, the rules implemented by a peer blockchain application 35 of an energy source 1 take account of a loss factor associated with that energy source 1 when transferring tokens to another party. This could be done either by incorporating a loss factor into the data stored for a token having the effect of reducing the amount of energy associated with the token, or by mandating that tokens corresponding to a certain amount of energy introduced into the energy distribution system 3 must be transferred to a bucket account of the type discussed above. It will be appreciated that such processing assists in providing information representing the energy flows in the energy provision system.

In some examples it is possible for an energy source 1 to be co-located with an energy sink 5, with the possibility of energy being supplied directly from the energy source 1 to the energy sink 5. For example, a large industrial premises may have significant renewable energy generations capabilities in the form of solar panels, wind turbines, air/ground source pumps and the like. The present invention can equally be applied to such systems, for example by having separate meters for energy generation and energy consumption or a two-way meter.

Although the description above has concentrated on an energy provision system in which energy is supplied to end users in the form of electricity, it will be appreciated that the same principles can be applied to an energy provision system in which energy is supplied to end users in other forms, such as gas and oil.

What is claimed is:

1. An energy provision system comprising:
a plurality of energy sources to introduce energy into the energy provision system;
a plurality of energy sinks for consuming energy;
an energy distribution system for distributing energy from the plurality of energy sources to the plurality of energy sinks; and
a distributed blockchain application arranged to link energy introduced by the plurality of energy sources with energy consumed by the plurality of energy sinks by recording transfers of tokens associated with said introduced energy in a blockchain.

2. An energy provision system according to claim 1, wherein a token indicates the provenance of the corresponding introduced energy.

3. An energy provision system according to claim 1, wherein the blockchain verifies the provenance of the introduced energy corresponding to a token.

4. An energy provision system according to claim 2, wherein a token indicates the form of production of the corresponding introduced energy.

5. An energy provision system according to claim 2, wherein a token indicates the time of introduction of the corresponding introduced energy.

6. An energy provision system according to claim 2, wherein the token indicates whether or not the form of production of said corresponding introduced energy is renewable.

7. An energy provision system according to claim 1, wherein the distributed blockchain application is arranged to control the transfer of tokens in dependence on a smart contract linking the transfer of token to a corresponding energy trade.

8. An energy provision system according to claim 7, wherein the token comprises at least some of the functionality of the smart contract.

9. An energy provision system according to claim 1, wherein the distributed blockchain application comprises a plurality of types of peer blockchain application, wherein the plurality of energy sinks comprise one type of peer blockchain application, wherein each type of peer blockchain application has associated transaction rules, and wherein the transactions rules for the plurality of energy sinks restrict the further transfer of tokens from the energy sinks to prevent tokens being transferred from an energy sink in association with an energy trade.

10. An energy provision system according to claim 9, wherein the energy distribution system has associated energy losses, and the rules associated with at least one type of peer blockchain application include a provision taking account of said energy losses.

11. An energy system according to claim 1, wherein the distributed blockchain application comprises a consensus mechanism in which blocks of transactions are generated at the plurality of energy sources.

12. An energy provision system according to claim 1, further comprising a computing platform arranged to facilitate the distributed blockchain application.

13. An energy provision system according to claim 12, wherein the computing platform is arranged, in response to receipt of data from an energy source indicating the introduction of an amount of energy into the energy provision system, to credit at least one token to an account associated with that energy source.

14. An energy provision system according to claim 13, wherein the computing platform is arranged to add a digital signature to each issued token to verify the authenticity of the issued token.

15. An energy provision system according to claim 1, wherein each of the plurality of energy sources comprises a meter for measuring energy introduced into the energy provision system by that energy source.

16. An energy provision system according to claim 15, wherein the meter is arranged to measure units of energy, and wherein the distributed blockchain application is arranged to associate a token with each unit of energy introduced into the energy provision system.

17. An energy provision system according to claim 1, wherein each of the energy sinks comprises a meter for measuring consumption of energy by that energy sink,
wherein the meter is arranged to report measurements of energy consumption to the distributed block chain application.

18. An energy provision system according to claim 1, wherein the energy provision system is arranged to provide energy in the form of electricity.

19. Energy source apparatus operable to introduce energy into an energy provision system, the energy source apparatus comprising:
a meter for measuring energy introduced into the energy provision system;
processor circuitry; and
a peer blockchain application forming part of a distributed blockchain application, the peer blockchain application comprising instructions which, when executed by the processor circuitry, cause the processor circuitry to perform calculations associated with the transfer of tokens,
wherein the meter is arranged to report measurements of energy introduced into the energy provision system to a token issuing system, thereby enabling tokens to be credited to an account associated the energy source apparatus in dependence on said amount of energy introduced into the energy provision system.

20. Energy sink apparatus comprising:
a meter for measuring energy consumed from an energy provision system;
processor circuitry; and
a peer blockchain application forming part of a distributed blockchain application, the peer blockchain application comprising instructions which, when executed by the processor circuitry, cause the processor to perform calculations associated with the transfer of tokens,
wherein the meter is arranged to report measurements of energy consumed to the distributed blockchain application, and wherein the peer blockchain application is arranged to perform transaction processing linking a transfer of tokens from another party to the energy sink apparatus with an energy trade associated with the provision of energy by said other party.
